(19) United States
(12) Patent Application Publication
(10) Pub. No.: US 2020/0212780 A1
(43) Pub. Date: Jul. 2, 2020

(54) Linear Motor

(71) Applicant: AAC Technologies Pte. Ltd., Singapore city (SG)

(72) Inventors: Yun Tang, Shenzhen (CN); Lubin Mao, Shenzhen (CN)

(21) Appl. No.: 16/703,827

(22) Filed: Dec. 4, 2019

(30) Foreign Application Priority Data
Dec. 29, 2018 (CN) 201822274322.1

(51) Int. Cl. H02K 33/18

(52) U.S. Cl. CPC H02K 33/18

(57) ABSTRACT

The present invention provides a linear motor including: a housing with an accommodation space; a vibrator and a stator; and elastic parts suspending the vibrator in the accommodation space. The elastic part includes an outer elastic part, and a first and second extension parts, and an inner elastic part spaced from the outer elastic part, a third extension part and a fourth extension part which respectively bend and extend from both ends of the second body part. The first extension part and the third extension part are connected; the second extension part and the fourth extension part are connected; the first body part, the second extension part, the fourth extension part, the second body part and the third extension part are connected for forming a hollow structure. The first fixation part is fixed to the housing, and the second fixation part is fixed to the vibrator.

### FIELD OF THE PRESENT DISCLOSURE

The present invention relates to a linear motor, particularly to a linear motor used in portable consumer electronic products.

### DESCRIPTION OF RELATED ART

With the development of electronic technology, portable consumer electronic products are more and more favored by people, such as mobile phones, handheld game consoles, navigation devices or handheld multimedia entertainment devices. These electronic products generally use linear motors for system feedback, such as the call reminder, information reminder and navigation reminder of mobile phones, vibration feedback of game consoles, etc.

In a relevant technology, a linear motor comprises a housing, a vibrating component, and an elastic part which suspends and supports the vibrating component in the housing. Generally, the elastic part is in a U shape. One end of the elastic part is connected with the housing, and the other end is connected with the vibrating component. The elastic part bears all stress generated by the vibrating component, and therefore, the elastic part is easy to deform during vibration, which decreases product reliability.

Thus, it is necessary to provide an improved linear motor to solve the problems above.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure.

FIG. 1 is an isometric view of a linear motor in accordance with an exemplary embodiment of the present invention.

FIG. 2 is an enlarged and exploded view of the linear motor of the exemplary embodiment.

FIG. 3 is an enlarged and isometric view of a main body of the linear motor of the exemplary embodiment.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiments described hereby is only to explain the disclosure, not intended to limit the disclosure.

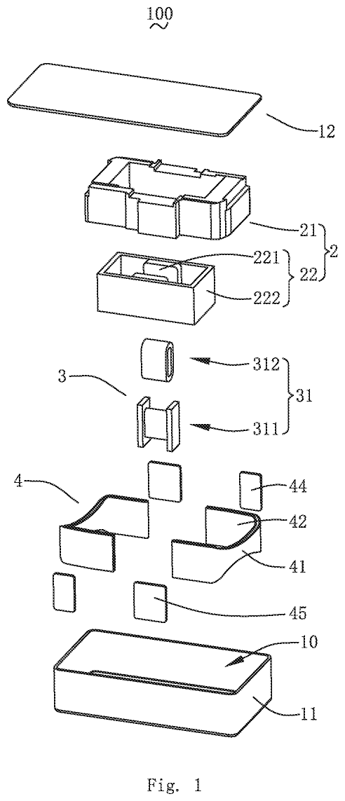

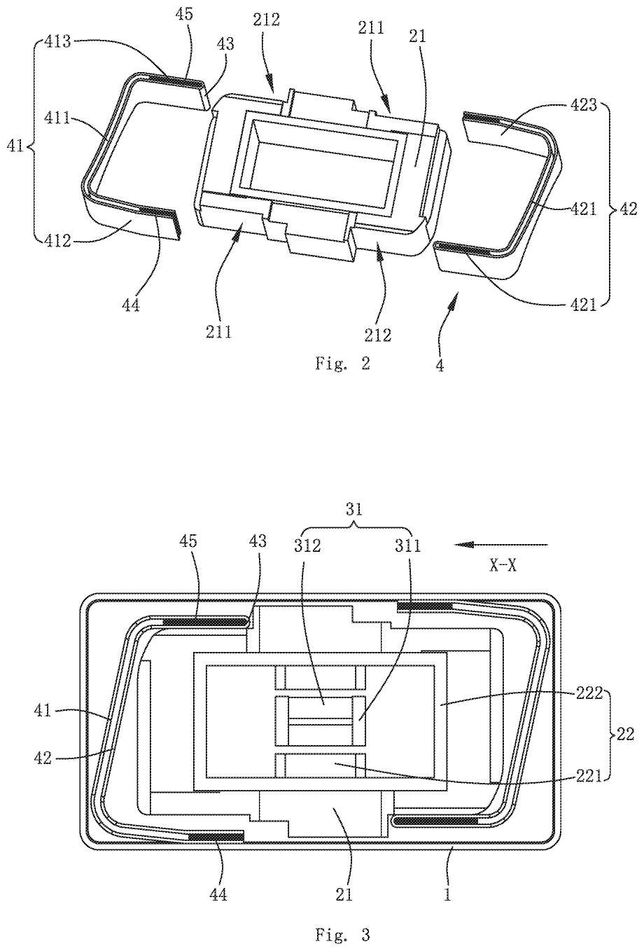

Please refer to FIGS. 1-3, an exemplary embodiment of the present invention provides a linear motor 100. The linear motor 100 comprises a housing 1 with an accommodation space 10, a vibrator 2 and a stator 3 accommodated in the accommodation space 10, and elastic parts 4 supporting and suspending the vibrator 2 in the accommodation space 10.

The housing 1 comprises a shell 11 and a cover plate 12 engaging with the shell 11 for cooperatively forming the accommodation space 10.

The vibrator 2 comprises a weight 21 and a magnet assembly 22 fixed to the weight 21. The weight 21 has an accommodating space, and the magnet assembly 22 is fixed and accommodated in the accommodating space. The magnet assembly 22 comprises a magnet 221 and a magnetic bowl 222 arranged at the periphery of the magnet 221.

The stator 3 comprises a coil assembly 31 comprising a coil support 311 fixed on the shell 11 and a coil 312 fixed on the coil support 311. The coil support 311 is disposed in the magnetic bowl 222. The magnet 221 is arranged around the coil support 311.

Two elastic parts 4 are arranged in this embodiment. Each end of the vibrator 2 is respectively connected with one elastic part 4 along the vibrating direction shown as X-X direction, i.e., the horizontal direction in FIG. 3.

The elastic parts 4 comprise an outer elastic part 41 and an inner elastic part 42 which are arranged in parallel with an interval. The shape of the inner elastic part 42 corresponds to the outer elastic part 41, wherein, the outer elastic part 41 comprises a first body part 411, and a first extension part 412 and a second extension part 413 which respectively bend and extend from both ends of the first body part 411. The first extension part 412 and the second extension part 413 extend in a same direction. The inner elastic part 42 comprises a second body part 421, and a third extension part 422 and a fourth extension part 423 which respectively bend and extend from both ends of the second body part 421. The third extension part 422 and the fourth extension part 423 extend in a same direction. The first extension part 412 and the third extension part 422 are connected at ends as the first fixation part. The second extension part 413 and the fourth extension part 423 are connected at ends of the second fixation part. The first extension part 412, the first body part 411, the second extension part 413, the fourth extension part 423, the second body part 421 and the third extension part 422 are connected in order to enclose to form a hollow structure. The first fixation part is fixed to the housing 1, and the second fixation part is fixed to the weight 21. The stress generated by the vibrator 2 during vibration is borne by the outer elastic part 41 and the inner elastic part 42. Compared with the related technology with only one elastic part, the elastic parts 4 in the present invention are more difficult to deform, and the linear motor 100 has better reliability.

An included angle between the first extension part 412 and the first body part 411, and an included angle between the third extension part 422 and the second body part 421, are less than or equal to 90 degrees. An included angle between the second extension part 413 and the first body part 411, and an included angle between the fourth extension part 423 and the second body part 421 are larger than or equal to 90 degrees.

Further, each of the elastic parts 4 comprise a connecting part 43 used for connecting the outer elastic part 41 and the inner elastic part 42. The connecting part 43 is arranged at ends of the first extension part 412 and the third extension part 422, or at ends of the second extension part 413 and the fourth extension part 423, which makes the outer elastic part 41 and the inner elastic part 42 enclose to form an U-shaped structure of which one end is open and the other end is closed. Preferably, the connecting part 43 is in an arc shape. More preferably, the outer elastic part 41, the inner elastic part 42 and the connecting part 43 are formed integrally, i.e., the elastic parts 4 are bent for multiple times to form a U-shaped hollow structure.

Further, each of the elastic parts 4 comprise a first welding sheet 44 and a second welding sheet 45, wherein, the first welding sheet 44 is arranged between and fixes the first extension part 412 and the third extension part 422 by welding, and the second welding sheet 45 is arranged between and fixes the second extension part 413 and the fourth extension part 423 by welding. The elastic parts 4 are stable in structure and difficult to deform.

Further, the weight 21 is provided with a first avoiding part 211 for avoiding the first fixation part, and a second avoiding part 212 for avoiding the second fixation part along both sides vertical to the vibrating direction. The first fixation part and the first avoiding part 211 are arranged with an interval, and the second fixation part and the second avoiding part 212 are fixed by welding.

Compared with relevant technologies, the elastic parts 4 in the linear motor 100 provided by the present invention are in a hollow structure. The outer elastic part 41 and the inner elastic part 42 of the elastic parts 4 respectively bear the stress generated by the vibrator 2 during vibration, and therefore, the elastic parts 4 are more difficult to deform. The linear motor 100 has improved reliability.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A linear motor comprising:
a housing with an accommodation space;
a vibrator and a stator accommodated in the accommodation space;
elastic parts supporting and suspending the vibrator in the accommodation space; each of the elastic parts including an outer elastic part having a first body part, and a first extension part and a second extension part which respectively bend and extend from both ends of the first body part, and an inner elastic part parallel to and spaced from the outer elastic part and including a second body part, a third extension part and a fourth extension part which respectively bend and extend from both ends of the second body part;
wherein
the first extension part and the third extension part are connected at ends of the first fixation part; the second extension part and the fourth extension part are connected at ends of the second fixation part; the first extension part, the first body part, the second extension part, the fourth extension part, the second body part and the third extension part are connected in order to enclose to form a hollow structure; the first fixation part is fixed to the housing, and the second fixation part is fixed to the vibrator.

2. The linear motor as described in claim 1, wherein the shape of the inner elastic part corresponds to the outer elastic part, the first extension part and the second extension part extend in a same direction, and the third extension part and the fourth extension part extend in a same direction.

3. The linear motor as described in claim 2, wherein an included angle between the first extension part and the first body part, and an included angle between the third extension part and the second body part are less than or equal to 90 degrees; an included angle between the second extension part and the first body part, and an included angle between the fourth extension part and the second body part are larger than or equal to 90 degrees.

4. The linear motor as described in claim 1, wherein the elastic parts also comprise a connecting part for connecting the outer elastic part and the inner elastic part; the connecting part is arranged at ends of the first extension part and the third extension part, or at ends of the second extension part and the fourth extension part, thereby making the outer elastic part and the inner elastic part enclose to form a U-shaped structure with one end open and another end closed.

5. The linear motor as described in claim 4, wherein the connecting part is in an arc shape.

6. The linear motor as described in claim 5, wherein the outer elastic part, the inner elastic part and the connecting part are formed integrally as a whole.

7. The linear motor as described in claim 1, wherein the elastic part further comprise a first welding sheet arranged between and fixes the first extension part and the third extension part into a whole by welding, and a second welding sheet arranged between and fixes the second extension part and the fourth extension part into a whole by welding.

8. The linear motor as described in claim 6, wherein the elastic part further comprise a first welding sheet arranged between and fixes the first extension part and the third extension part into a whole by welding, and a second welding sheet arranged between and fixes the second extension part and the fourth extension part into a whole by welding.

9. The linear motor as described in claim 1 including two elastic parts, wherein each ends of the vibrator respectively connects to one elastic part along the vibrating direction.

10. The linear motor as described in claim 8, wherein the vibrator comprises a weight and a magnet assembly fixed to the weight; the weight is provided with a first avoiding part for avoiding the first fixation part, and a second avoiding part for avoiding the second fixation part along both sides vertical to the vibrating direction; the first fixation part and the first avoiding part are arranged with an interval therebetween, and the second fixation part and the second avoiding part are fixed by welding.

11. The linear motor as described in claim 1, wherein the stator comprises a coil assembly having a coil support fixed on the housing and a coil fixed on the coil support.
